(19) United States
(12) Patent Application Publication
(10) Pub. No.: US 2005/0123148 A1
(43) Pub. Date: Jun. 9, 2005

(54) Motorcycle audio system

(76) Inventor: Robert E. Ohler, Canton, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/991,806

(22) Filed: Nov. 18, 2004

Related U.S. Application Data
(60) Provisional application No. 60/523,863, filed on Nov. 20, 2003.

(51) Int. Cl. H04B 1/00; H04B 1/06

(52) U.S. Cl. 381/86; 224/413; 455/345

(57) ABSTRACT

An audio system for an open vehicle such as a motorcycle, an ATV, or the like that has a handlebar. A face plate having a plurality of control switches that control the operation of the audio system is attached to a face plate receptacle. The face plate receptacle is secured to the handlebar assembly. Components of the audio system are contained within a housing and secured to the frame of the motorcycle at a remote location relative to the handlebar. A wiring harness connects the faceplate receptacle to the components of the audio system contained in the housing. Speakers are also provided on the handlebar or in a helmet of a rider.

### CROSS-REFERENCE TO RELATED APPLICATIONS

This application claims the benefit of U.S. provisional application Ser. No. 60/523,863 filed Nov. 20, 2003.

### BACKGROUND OF THE INVENTION

1. Field of the Invention

The present invention relates to an audio system for a motorcycle.

2. Background Art

An audio system is a popular accessory for motorcycles. Examples of audio systems include radios, tape players, CD players, digital music players, and the like. The weight and bulk of vehicle audio systems present one problem when they are attempted to be assembled to a motorcycle. Another problem is that the audio system controls and display must be attached to the motorcycle at a front and center location or it will be difficult to operate.

One example of a prior art attempt is disclosed in U.S. Published Application 2002/0131606 published on Sep. 19, 2002, but discloses a motorcycle audio system in which the radio is mounted in its entirety on a windshield assembly. The motorcycle audio system is disposed in a generally vertical orientation relative to the windshield assembly and also includes speakers mounted adjacent opposite sides of the radio. The problem with this system is that it is large and adds a substantial amount of weight to the handlebar and front end assembly. This system is also vulnerable to theft.

Another audio system for a bicycle is disclosed in U.S. Pat. No. 5,771,305. The system described in the '305 patent proposes including an AM/FM radio, a cassette or CD player and also proposes storing the entire audio system in a bag that is removably mounted on the handlebar. This system suffers from the same disadvantages as the '606 publication.

Another proposed solution is disclosed in U.S. Pat. No. 4,445,228 that discloses a stereo audio system for a motorcycle that is assembled to base socket assemblies that are associated with handlebar mounted mirrors. The mirrors also include speakers that are mounted to the mirror side of the mirror assemblies.

Another proposed solution is disclosed in U.S. Pat. No. 5,222,752 that discloses a radio system for a two wheeled bicycle that includes a radio system mounted into a windshield faring assembly. All of the components of the radio are mounted on the handlebar as part of the windshield faring assembly. The '752 patent also discloses the use of a saddlebag that may be used to contain solar collectors that are used to recharge a battery contained in the windshield faring assembly.

All of the above proposed solutions involve adding bulky accessories to an already crowded handlebar area.

One way to provide an audio system for a motorcycle that does not encumber the handlebar area is to provide an audio system that may be carried in a saddlebag of a motorcycle. This potential solution, while eliminating the problems associated with mounting a radio on a handlebar, is subject to the disadvantage of being difficult to operate. If an audio system is placed in the saddlebag of a motorcycle, it is nearly impossible while driving to change radio channels, adjust volume, or change tracks of a stored music player such as a tape player, CD player or digital music player. The saddlebags are not normally secure, so an audio system contained in a saddlebag could be stolen.

These and other disadvantages and shortcomings of the prior art are addressed by Applicant's invention, as summarized below.

### SUMMARY OF THE INVENTION

According to one aspect of the present invention, an audio system is provided for an open vehicle such as a motorcycle, an ATV, or the like that is steered with a handlebar. A housing containing a plurality of component parts of the audio system is secured to the motorcycle at a location that is remote relative to the handlebar. A face plate receptacle has clamps or other brackets that are used to secure the receptacle to the handlebar. A wiring harness connects the faceplate receptacle to the components of the audio system contained in the housing. A face plate having a plurality of control switches that control the operation of the audio system of the audio system is attached to the face plate receptacle.

According to another aspect of the present invention, an audio system for a motorcycle is provided. The motorcycle comprises a frame supporting a motor and a rear drive wheel, a seat, and a storage compartment such as a saddlebag. The motorcycle also includes a front assembly comprising a front wheel and handlebars connected by a front fork. An audio system is installed on the motorcycle that has a detachable face plate. The audio system has a face plate sub-assembly, a housing for a plurality of electrical components of the audio system, a face plate housing that receives the face plate sub-assembly, and a wiring harness electrically connecting the face plate sub-assembly to the plurality of electrical components. The face plate subassembly, and the face plate housing that receives the face plate assembly are secured to the front assembly of the motorcycle. The housing for the plurality of electrical components of the audio system is secured to the frame of the motorcycle.

According to other aspects of the invention, the face plate may be a detachable face plate of the type that may have been adapted to be secured to an audio system for a vehicle instrument panel, but is instead attached to the face plate receptacle. One of the control switches of the face plate may be the tuner control. Another of the control switches of the face plate may be the stored music player controls. Other control switches on the face plate may be a volume control, a power control, a plurality of preset channel selection control switches, a balance control, and a tone control.

According to other aspects of the invention that relate to the speakers of the audio system, at least one audio speaker may be electrically connected to the audio system to provide the audio output of the audio system. The speakers may be secured to the handlebar of the motorcycle.

According to other aspects of the invention as it relates to the connection of the face plate to the face plate housing, the face plate receptacle may have a multi-pin connector receptacle that is connected to the wiring harness, and wherein the faceplate has a multi-pin plug that corresponds to the multi-pin connector receptacle. The multi-pin connector receptacle may be a remounted multi-pin connector receptacle that was originally mounted on the audio system housing. The face plate is detachable from the face plate receptacle to discourage theft of the audio system from the motorcycle.

These and other aspects of the invention will be better understood in view of the attached drawings and the following detailed description of the illustrated embodiment of the invention.

### BRIEF DESCRIPTION OF THE DRAWINGS

FIG. 1 is a fragmentary and partially diagrammatic perspective view of a motorcycle and an audio system;

FIG. 2 is a fragmentary and partially diagrammatic perspective view of a motorcycle and audio system as shown in FIG. 1 with the face plate subassembly removed;

FIG. 3 is a schematic plan view of an audio system for motorcycle; and

FIG. 4 is a fragmentary partially diagrammatic elevation view of an audio system for a motorcycle.

### DETAILED DESCRIPTION OF THE ILLUSTRATED EMBODIMENT

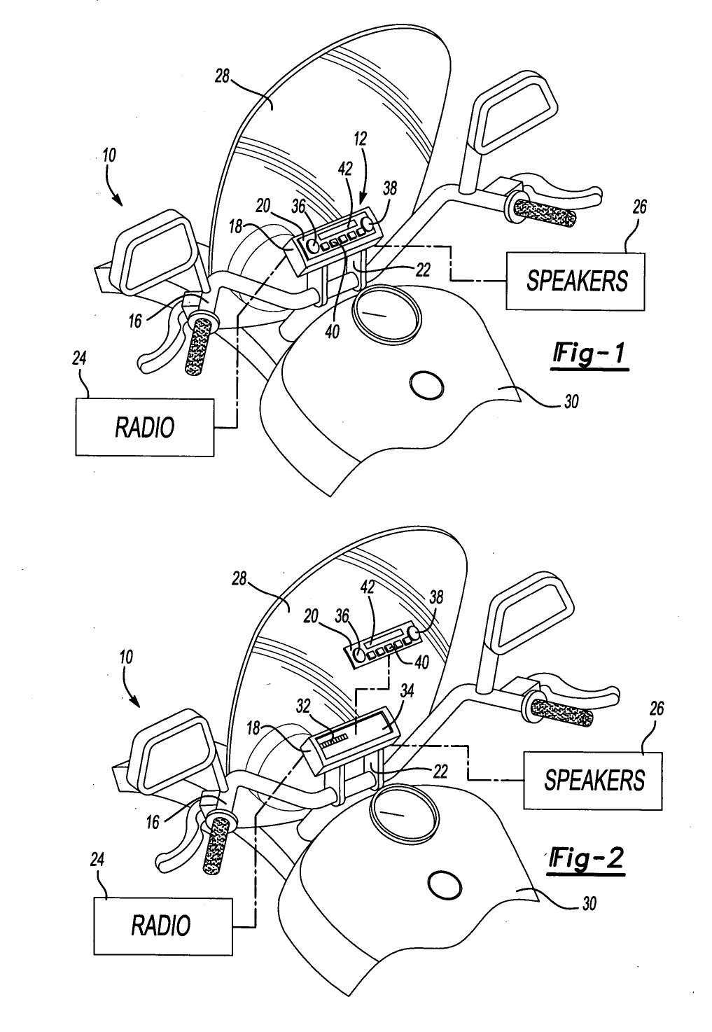

Referring now to FIGS. 1 and 2, a motorcycle generally indicated by reference numeral 10 is fragmentarily illustrated in conjunction with an audio system generally indicated by reference numeral 12. The handlebar 16 of motorcycle 10 is adapted to receive a faceplate receptacle 18, or faceplate housing. A faceplate subassembly 20 comprising a detachable faceplate is shown in FIG. 1 as it is assembled to the faceplate receptacle 18. In FIG. 2, the faceplate subassembly is shown detached from the faceplate housing 18. The faceplate receptacle 18 is secured to handlebar 16 by means of brackets 22, or clamps that may be tightened to securely anchor the faceplate receptacle 18 to the handlebar 16.

An audio system electrical component housing 24 is shown diagrammatically in FIGS. 1 and 2 and is identified by the block identified as “RADIO.” While the block is labeled RADIO, it should be understood that it refers to electrical components, other than the controls and display panel, such as a tape player, CD player, MP3 player, or the like that are contained in a housing.

A plurality of speakers 26 are shown diagrammatically in FIGS. 1 and 2. The speakers 26 are preferably also mounted on the handlebar 16 or any other location that would provide an audio output to the motorcycle rider. Alternatively, speakers or earphones could be mounted to the motorcycle rider's helmet. The speakers or earphones could be connected by either wires or a radio frequency link.

A front faring 28 is shown in FIGS. 1 and 2 in diagrammatic form. The front faring 28 may take many forms including a full windshield, partial windshield or a molded windbreak panel. A gas tank 36 is also shown in FIGS. 1 and 2 to provide a partial representation of the body of the motorcycle 10. The other parts of the motorcycle that are not shown are of conventional design.

Referring now to FIG. 2, a multi-pin receptacle 32 is provided on the faceplate receptacle 18 inside a cavity 34 defined by the faceplate receptacle 18. The faceplate 20 is preferably of conventional design and may include either an analog or a digital radio control. In the illustrated embodiment, an analog tuner is shown wherein an on/off and volume knob 36 is provided on the left side of the faceplate 20. An analog tuning knob 38 is provided on the right side that may also include tone and balance adjustments as is well known in the art. A plurality of preset channel selection control switches 14 are shown on the faceplate 20. A display screen 42 is provided on the faceplate 20 and may be either an analog or a digital display.

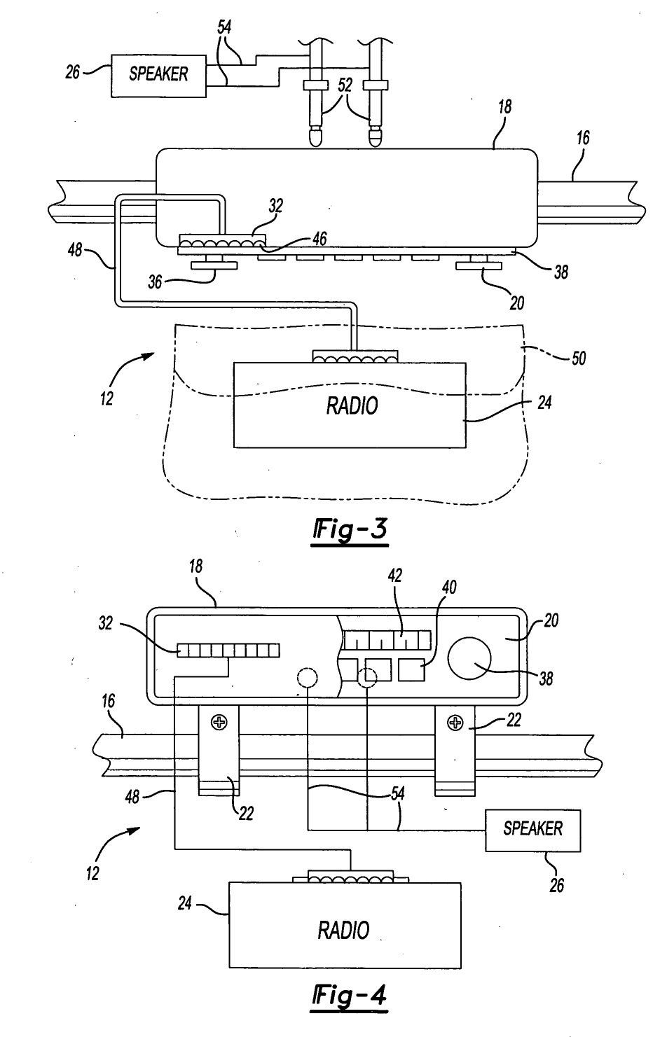

Referring now to FIGS. 3 and 4, the audio system 12 is illustrated schematically in greater detail. The faceplate housing 18 is shown secured to the handlebar 16 by means of brackets 22. The detachable faceplate 20 is shown installed in the faceplate housing 18 in FIG. 3 and is fragmentarily shown in FIG. 4.

In FIG. 3, the faceplate 20 is shown connected by a multi-pin plug 46 that is connected through the multi-pin receptacle 32 to the wiring harness 48. The wiring harness 48 is connected to the audio system electrical component housing 24 that may be stored in a saddlebag 50.

Speaker jacks are shown in FIG. 3 that enable the speaker 26 to be connected to the faceplate receptacle 18 to receive the audio output from the audio system 12. Speaker wires 54 are shown connecting the speaker jacks 52 to the speakers 26.

The audio system 12 of the present invention is operated by mounting the faceplate receptacle 18 on a handlebar 16 of a motorcycle 10. The detachable faceplate may be the faceplate from a radio having a detachable faceplate. If so, the audio system electrical component housing 24 may be from the same radio as the detachable faceplate 20. A wiring harness 48 connects the detachable faceplate 20 through the faceplate receptacle 18 to the audio system electrical component housing 24. The audio system electrical component housing 24 may be stored in a saddlebag 50 that is in turn attached to the motorcycle 10 adjacent the rear wheel (not shown). Speakers 26 may be mounted on either the handlebar or in the helmet of a motorcycle rider. The speakers 26 may be connected to the faceplate receptacle 18 by means of speaker wires 54. The motorcycle rider can easily control the audio system by, for example, adjusting on/off volume knob 28, tuning knob or tone/balance adjustment knob 39 and preset channel selection control switches 40. The rider may also adjust these or other knobs to control a CD player, tape player, or digital music player. CDs, tapes and digital music media would be loaded into the audio system electrical component housing 24 that is stored in the saddlebag and remotely operated by means of the faceplate 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An audio system for an open vehicle having a handlebar, comprising:
a housing secured to the motorcycle at a remote location relative to the handlebar, the housing containing a plurality of component parts of the audio system;
a face plate receptacle is secured to the handlebar;
a wiring harness connects the faceplate receptacle to the components of the audio system contained in the housing;
a face plate of the audio system attached to the face plate receptacle and has a plurality of control switches that control the operation of the audio system.

2. The audio system of claim 1 wherein the face plate is a detachable face plate that is attached to the face plate receptacle.

3. The audio system of claim 1 wherein one of the control switches of the face plate is the tuner control.

4. The audio system of claim 1 wherein one of the control switches of the face plate is the stored music player controls.

5. The audio system of claim 1 wherein the control switches of the face plate are a volume control, a power control, a plurality of preset channel selection control switches, a balance control, and a tone control.

6. The audio system of claim 1, further comprising at least one audio speaker electrically connected to the audio system to play the audio output of the audio system.

7. The audio system of claim 6 wherein the speakers are secured to the handlebar of the motorcycle.

8. The audio system of claim 1 wherein the face plate receptacle has a multi-pin connector receptacle that is connected to the wiring harness, and wherein the faceplate has a multi-pin plug that corresponds to the multi-pin connector receptacle.

9. The audio system of claim 8 wherein the multi-pin connector receptacle is a remounted multi-pin connector receptacle that was originally mounted on the audio system housing.

10. The audio system of claim 1 wherein the face plate is detachable from the face plate receptacle to discourage theft of the audio system from the motorcycle.

11. A motorcycle and audio system, in combination, comprising:
a motorcycle comprising a frame supporting a motor and a rear drive wheel, a seat secured to the frame and at least one saddlebag secured to the frame, the motorcycle further comprising a front assembly comprising a front wheel, a front fork, and handlebars;
an audio system comprising a detachable face plate audio apparatus comprising a face plate sub-assembly, a housing for a plurality of electrical components of the audio system, a face plate housing that receives the face plate sub-assembly, and a wiring harness electrically connecting the face plate sub-assembly to the plurality of electrical components through the face plate housing; and
wherein the face plate sub-assembly, and the face plate housing that receives the face plate sub-assembly are secured to the front assembly of the motorcycle, and the housing for the plurality of electrical components of the audio system is secured to the frame of the motorcycle.

12. The motorcycle and audio system of claim 11 wherein the face plate subassembly is a detachable face plate that is adapted to be secured to the housing but is instead attached to the face plate housing.

13. The motorcycle and audio system of claim 11 wherein one of the control switches of the face plate subassembly is the tuner control.

14. The motorcycle and audio system of claim 11 wherein the face plate subassembly further comprises a plurality of control switches and wherein one of the control switches of the face plate subassembly is the stored music player controls and the stored music player is one of the electrical components contained within the housing.

15. The motorcycle and audio system of claim 11 wherein the face plate subassembly further comprises a plurality of control switches and wherein the control switches of the face plate subassembly further comprise a volume control, a power control, a plurality of preset channel selection control switches, a balance control, and a tone control.

16. The motorcycle and audio system of claim 11, further comprising at least one audio speaker electrically connected to the face plate housing to play the audio output of the audio system.

17. The motorcycle and audio system of claim 16 wherein the speakers are secured to the handlebar of the motorcycle.

18. The motorcycle and audio system of claim 11 wherein the face plate housing has a multi-pin connector receptacle that is connected to the wiring harness, and wherein the faceplate subassembly has a multi-pin plug that corresponds to the multi-pin connector receptacle.

19. The motorcycle and audio system of claim 18 wherein the multi-pin connector receptacle is a remounted multi-pin connector receptacle that was originally mounted on the audio system housing.

20. The motorcycle and audio system of claim 11 wherein the face plate subassembly is detachable from the face plate housing to discourage theft of the audio system from the motorcycle.
